(19) United States
(12) Patent Application Publication
(10) Pub. No.: US 2020/0049937 A1
(43) Pub. Date: Feb. 13, 2020

(54) LENS MODULE

(71) Applicant: AAC Technologies Pte. Ltd., Singapore city (SG)

(72) Inventors: Tuomas Punta, Shenzhen (CN); Ville Nummela, Shenzhen (CN); Ossi Pirinen, Shenzhen (CN); Eero Päivänsalo, Shenzhen (CN); Tomi Lintulahti, Shenzhen (CN)

(21) Appl. No.: 16/198,326

(22) Filed: Nov. 21, 2018

(30) Foreign Application Priority Data
Aug. 9, 2018 (CN) 201821283406.5

(51) Int. Cl. G02B 7/09; G03B 13/36; G02B 27/64; G03B 5/00; G02B 13/04; G02B 13/02

(52) U.S. Cl. CPC G02B 7/09; G03B 13/36; G02B 27/646; G03B 2205/0007; G02B 13/04; G02B 13/02; G03B 5/00

(57) ABSTRACT

The present disclosure relates to the technical field of optical imaging, and in particular, to a lens module. The lens module includes a first lens module and a second lens module. The first lens module is an autofocus module and includes a first lens for imaging and a focus actuator for driving the first lens to perform autofocus. The focus actuator includes a first accommodating space for accommodating the first lens. The second lens module is a fixed-focus module and includes a second lens. The lens module according to the present disclosure can provide an image with good quality at low cost.

### CROSS-REFERENCE TO RELATED APPLICATIONS

The present application claims priority to Chinese Patent Application No. 201821283406.5, filed on Aug. 9, 2018, the content of which is incorporated herein by reference in its entirety.

### TECHNICAL FIELD

The present disclosure relates to the technical field of optical imaging, and in particular, to a lens module.

### BACKGROUND

Along with the development of technologies, more and more imaging devices are equipped with multiple lenses (or cameras), so as to achieve a wider viewing angle or make farther objects be imaged more clearly. For example, many cellphones are equipped with a lens module including two cameras or more cameras, so as to achieve a zooming effect. Such lens module generally includes the following types: a lens module including a wide-angle lens and a telephoto lens, a lens module including a wide-angle lens and a super wide-angle lens, and the like, so as to improve the user experience and facilitate the user using and operating the lens module to take a relatively good photo.

As shown in FIG. 1, during the design of a lens module 100′, each of two cameras included in the lens module 100′ is equipped with the autofocus function, and the user can take a photo with a reliable quality based on this function. However, the autofocus function usually needs to be implemented by means of a corresponding actuator, and installation of the actuator would occupy a certain space in the lens module, resulting in a larger size of the lens module. In addition, due to the limitation of the autofocus function itself, the imaging effect may be greatly decreased for objects farther away from the lens module, so that the autofocus function of the telephoto lens cannot achieve its due effect, thus resulting in an over-design problem.

In addition, users are looking for better specifications, such as a combination of a wide-angle and a telephoto, with which an optical zoom ratio of more than two times could be achieved without combining optical solutions or significantly increasing the thickness of the product.

### BRIEF DESCRIPTION OF DRAWINGS

FIG. 1 is a schematic structural diagram of a lens module in the prior art;

FIG. 2 is a schematic structural diagram of a lens module according to a first embodiment of the present disclosure; and

FIG. 3 is a schematic structural diagram of a lens module according to a second embodiment of the present disclosure.

The drawings herein are incorporated into and constitute a part of the present specification, which show the embodiments of the present disclosure and illustrate the principles of the present disclosure together with the specification.

### DESCRIPTION OF EMBODIMENTS

The present disclosure will be further described in the following with reference to specific embodiments and accompanying drawings.

### First Embodiment

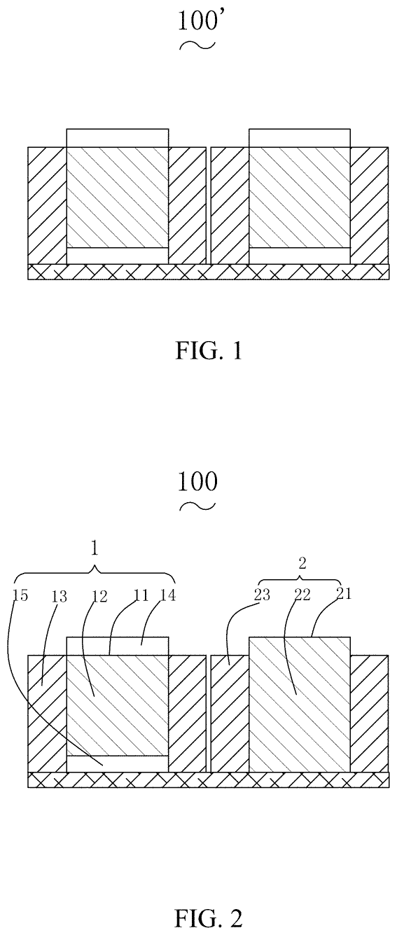

As shown in FIG. 2, a first embodiment of the present disclosure provides a lens module 100. The lens module 100 includes a first lens module 1 and a second lens module 2, both of which can be used for imaging. Before outputting a final image, the imaging device can use two sets of images provided by the first lens module 1 and the second lens module 2 as materials, and optimizes the two sets of images by means of hardware in the imaging device based on the pre-installed software and the preset algorithm, so as to output the best image to the user as much as possible. The first lens module 1 is an autofocus module, which includes a first lens 11 for imaging and a focus actuator 13 for driving the first lens 11 to automatically focus. The focus actuator includes a first accommodating space 12 for accommodating the first lens 11. Specifically, the first lens 11 can include a plurality of optical lenses, and the plurality of optical lenses can include different types of optical lenses. The specific allocation and arrangement of the plurality of optical lenses in the first lens 11 can be determined according to actual needs and design schemes and will not be further described herein. FIG. 2 is merely a schematic structural diagram of a specific embodiment of the present disclosure. The first lens 11 and the focus actuator 13 can be connected to each other through a screw connection and can move relatively as needed, thereby improving the image quality by changing the object distance of the first lens module 1 under the action of the focus actuator. The second lens module 2 is a fixed-focus module, which includes a second lens 21. Correspondingly, the second lens 21 can also include a plurality of different types of optical lenses, and the combination and arrangement of the plurality of optical lenses can be designed according to the actual situation. When the second lens module 2 is a fixed-focus module, the cost can be reduced and the space occupied by the second lens module 2 can be reduced. Specifically, the focal length thereof can be selected according to design needs. During the assembly of the lens module, the first lens module 1 and the second lens module 2 can be arranged in a direction perpendicular to a thickness direction of the first lens 11, and both of them can adopt an electrical connection manner to achieve communication connection with image receiving components in the imaging device. Meanwhile, for the imaging device, since the second lens module 2 is not provided with a focus actuator, the space occupied by the second lens module 2 is relatively small, and the saved space can be used for mounting or accommodating other components in the device such as the imaging device, thereby solving the over-design problem. Alternatively, when there is a fixed reserved space in the second lens module 2, the saved space can improve the design freedom of the second lens 21, thereby improving the performance of the entire lens module in other aspects, achieving an optical zoom ratio of more than two times and improving the competitiveness of the entire lens module.

In summary, the lens module provided by the present disclosure includes the first lens module 1 and the second lens module 2, both of which can be used for imaging. The first lens module 1 of the lens module includes the focus actuator, and the focus actuator includes the first accommodating space 12 for accommodating the first lens 11. The first lens module 1 has an autofocus function under the action of the focus actuator. Meanwhile, the second lens module 2 of the lens module includes the second lens 21, and the second lens module 2 is a fixed-focus module. It is known from the above that the lens module provided by the present disclosure has the autofocus function, which can improve quality of photos taken by a user who is poor in the photography technology to a certain extent, thereby ensuring that the photos taken by the entire lens module can satisfy the quality requirement. Meanwhile, the second lens module 2 of the lens module is a fixed-focus module, which is not provided therein with a focus actuator, thereby saving the cost of the design and production of the entire lens module and thus improving the competitiveness of the entire lens module.

In the autofocus module, a space of a certain thickness needs to be reserved in the moving direction of the lens for the movement of the lens during autofocusing. Specifically, an upper space 14 and a lower space 15 are reserved respectively on the upper and lower sides of the first lens 11. In the fixed-focus module, there is no need to reserve a space for the movement, so that the lens can be designed with a larger space for achieving a larger zoom ratio and a better aberration correction.

Further, the first lens module 1 can further include a first anti-shake actuator, and the first anti-shake actuator and the focus actuator 13 can be designed into an integrated structure, which can greatly improve the assembly efficiency of the lens module. The first anti-shake actuator can also be communicatively connected to a control component in the imaging device by an electrical signal. For example, devices such as a gyroscope can be provided in the imaging device or in the lens module, so that when the gyroscope feels that the lens module is shaking, the shaking of the lens module can be timely outputted in a form of an electric signal or the like to the control component. Then, the control component can quickly analyze the shaking of the lens module according to the pre-installed program and the preset algorithm and achieve a solution corresponding to the shaking. The solution is transmitted in a form of an electrical signal to the first anti-shake actuator. In this way, by changing the position of the first lens 11, i.e., the position of the imaging plane relative to the first lens module 1, the first anti-shake actuator can basically eliminate the adverse influence on the resulting image due to the shaking of the lens module. Specifically, when the lens module is shaking, the anti-shake actuator can drive the first lens 11 to generate an anti-shake motion having an opposite direction and a same distance (amplitude) with respect to the abovementioned shaking, thereby even eliminating the adverse influence on the imaging effect resulting from the unexpected shaking of the lens module and thus ensuring good imaging quality of the lens module.

Similarly, in order to make the second lens module 2 take a photo with good quality in the case of unexpected shaking of the lens module, preferably, the second lens module 2 can include a second anti-shake actuator 23. The second anti-shake actuator 23 has a same structure as the first anti-shake actuator. The second anti-shake actuator 23 includes a second accommodating space 22 for accommodating the second lens 21. In this way, after receiving an anti-shake signal from the control component of the imaging device, the second lens 21 can be controlled to generate a corresponding anti-shake motion, so as to counteract the adverse influence on the imaging quality of the second lens module due to the unexpected shaking of the lens module.

It should be noted that, in order to facilitate the description and limitation of the specific content of the present disclosure, the lens in the present disclosure can either refer to a camera lens or refer to a camera in a portable device such as a cellphone or a tablet computer, and no specific distinction is made herein. In addition, the control component can be disposed outside the lens module or within the lens module. No matter where the control component is installed, the control component has a communication connection with the focus actuator and the anti-shake actuator. In this way, when the control component detects that the lens module requires for a focusing action and anti-shake, corresponding signals (i.e., a focus signal and an anti-shake signal) can be outputted to the focus actuator and the anti-shake actuator, such that the focus actuator and the anti-shake actuator can perform corresponding actions for achieving autofocus and anti-shake.

Further, in order to make the entire lens module achieve a better imaging effect, optionally, the second lens module 2 can further include an iris diaphragm. The iris diaphragm can be disposed at the light side of the second lens 21, i.e., the position before the light enters the optical lens. It is known that the diameter of a finished optical lens cannot be arbitrarily changed. Therefore, although an individual optical lens has a fixed amount of incoming light, the amount of light entering the optical lens can be changed by providing an area-changeable hole-shaped grating with a polygonal or circular shape at one side of the optical lens. Such a structure is an iris diaphragm, which can take a photo having a better effect and quality by changing the amount of light entering the optical lens. By providing an iris diaphragm in the second lens module 2, the installation space in the second module can be fully utilized. Meanwhile, for different scenarios, the user or the imaging device itself can change the amount of light entering the second lens module 2 by means of the iris diaphragm, so as to optimize the quality of the photo. For example, when it is dark, the imaging quality can be improved by increasing the amount of light entering the iris diaphragm. In addition, when the background needs to be blurred or the subject needs to be highlighted, the amount of light entering the iris diaphragm can also be increased. When a long exposure is required, the amount of light entering the iris diaphragm can be decreased so as to increase time for clicking the shutter, thereby improving the imaging quality. It is known from the above that, by providing the iris diaphragm in the second lens module 2, the entire lens module can be applied to a variety of light conditions as well as a variety of shooting scenarios, thereby further improving the quality of the photo taken by the lens module and thus improving the competitiveness of the product. Of course, a communication connection between the iris diaphragm and the control component can be achieved by an electrical signal or the like. The control component can obtain the real-time light condition of the environment where the lens module is located by means of image sharpness or by means of a photosensitive element, and then send an adjustment signal to the iris diaphragm according to a preset algorithm, so that the iris diaphragm can perform a corresponding action according to the adjustment signal, so as to change the amount of light entering the second lens module 2.

The second lens module 2 can be provided with other components. Optionally, the second lens module 2 can be provided with a mechanical shutter. With the advancement of technologies, electronic shutters with the lower cost and simple structure have become more and more popular. However, mechanical shutters cannot be completely replaced by the electronic shutters due to the unique structure and function. For example, an electronic shutter cannot be used in a scenario where a long exposure is required. In addition, since the electronic shutter lacks physical shading, its photoreceptor is in a state of being continuously illuminated by light rays and the light is converted into an electrical signal to be outputted, even when the shutter action is started, there is residual charge on the photosensitive unit of the photoreceptor, which may adversely affect the image quality. The working action of the mechanical shutter would allow the photoreceptor to have a moment being in an environment without light, and at this moment, the photoreceptor can be initialized to an optimal state. Therefore, in some cases, the performance of the mechanical shutter is better than that of the electronic shutter, and correspondingly the imaging quality of the entire lens module can be improved. Specifically, the mechanical shutter can be driven by a pure mechanical structure or a mechanical-electromagnetic structure. For the pure mechanical structure, it can adopt mechanical transmission and spring delay to drive the shutter curtain or hinge to act. For the mechanical-electromagnetic structure, it can adopt mechanical transmission and electromagnetic trigger to drive the shutter curtain or hinge to act. In the assembly process of the lens module, depending on the actual size of the second lens module 2, a mechanical shutter with a corresponding size can be mounted at the light side of the second lens 21, i.e., the side of the light entering the second lens 21.

Further, in the actual design and manufacturing process of the lens module, the first lens module 1 can be designed as a standard lens, a wide-angle lens, a super wide-angle lens, or a telephoto lens according to different requirements of the customer or the user, thereby forming lens modules having different imaging effects together with the second lens module 2, so as to meet different requirements. Preferably, the first lens 11 and the second lens 21 are respectively a wide-angle lens having a focal length f1 and a telephoto lens having a focal length f2. The wide-angle lens can achieve a wide viewing angle, while the telephoto lens has a long focal length and a narrow viewing angle. The lens module formed by such a combination has a good imaging effect. More specifically, the first lens module includes a first sensor, and the first sensor has a pixel size of p1; and the second lens module includes a second sensor, and the second sensor has a pixel size of p2. The lens module has a magnification Z==(f2/f1)*(p1/p2), which satisfies that Z≥2 so as to further improve the imaging quality. The thickness of the first lens module 1 can be equal to the thickness of the second lens module 2, so as to reduce the assembly difficulty of the grouping process of the two modules. Alternatively, the thickness of the first lens module 1 can be not equal to the thickness of the second lens module 2, so as to adapt to different assembly environments. Generally, the height of the telephoto lens is larger than that of the wide-angle lens, that is, the thickness of the second lens module 2 is larger than that of the first lens module 1.

Optionally, since the second lens module 2 has a constant focal length and a relatively sufficient installation space inside, the second lens module 2 can also be designed as a wide-angle lens. Generally, the fixed-focus wide-angle lens has a relatively large amount of light entering it, and the imaging can be well done even when the light is relatively insufficient. The fixed-focus wide-angle lens has a relatively small minimum focusing distance, so that the lens module can be very close to the subject and can get a large image. The wide-angle segment has a better imaging effect. Accordingly, the fixed-focus wide-angle lens has a relatively small volume and small mass, thereby facilitating installation and saving space. Alternatively, the thicknesses of the first lens module 1 can be equal to the thickness of the second lens module 2, so as to reduce the assembly difficulty of the grouping process of the two modules.

Since the second lens module 2 is a fixed-focus lens and is not provided with a focus actuator, there is a relatively large installation space remaining in the second lens module 2 when the outer size of the second lens module 2 is equal to the outer size of the first lens module 1, that is, a range of a preset focal length available for the second lens module 2 is relatively wide. Optionally, the second lens module 2 can also be designed as a telephone lens. The telephoto lens has a long focal length and a narrow viewing angle, so that it has a better imaging effect for objects that are far away from the lens. Meanwhile, the telephoto lens has a relatively small field depth, so that it can more effectively blur the background, so as to highlight the focus subject. In addition, the telephoto lens has a relatively small amount of deformation in the perspective of the portrait, so that the telephoto lens can take the more vivid portrait and thus the entire lens module can have a more excellent performance in the scenes of the portrait imaging.

The present disclosure further provides an imaging device, which includes a control component, an image receiving component, and a lens module according to any of the above embodiments. The control component may be a microcomputer or other electronic component having functions for processing images and data. A communication connection between the control component and the focus actuator can be established by an electrical signal, so that after the control component comparatively analyzes an initial image formed by the first lens module 1, a focus signal can be sent to the focus actuator so as to control the focus actuator to drive the first lens 11 to move so as to change the focal length of the first lens module 1, thereby improving the imaging quality. Correspondingly, the image receiving component can also be communicatively connected to the first lens module 1 and the second lens module 2 by means of electrical signals. The first lens module 1 has an autofocus function, so that in most situations it can perform the focusing action with respect to objects photographed by the lens module. When an object to be photographed is relatively far from the lens module, the user can move the position of the imaging device in such a manner that the object to be photographed can form a clearer image on its imaging plane by means of the second lens module 2 having a fixed focal length. In this way, in different imaging scenes or under different imaging requirements, the image receiving component can optimize images formed by the first lens module 1 and the second lens module 2, thereby outputting a final image having the best quality and effect.

### Second Embodiment

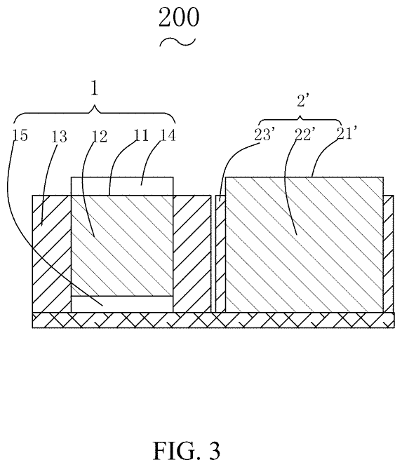

As shown in FIG. 3, the second embodiment and the first embodiment are substantially the same, and the different lies in that in the lens module 200 provided by the second embodiment, the second lens module 2′ includes a second lens 21′ and a base 23′ having an accommodating space 22′, and the second lens module 2′ has neither of the focus actuator and the anti-shake actuator. Such design can further increase the design space of second lens 21′, so that the second lens module 2′ has a longer focal length, thereby resulting in a larger zoom ratio Z′ and a better aberration correction for the lens module 200.

The above-described embodiments are merely preferred embodiments of the present disclosure and are not intended to limit the present disclosure. Various modifications and changes can be made by those skilled in the art. However, any modifications, equivalent substitutions and improvements made within the principle of the present disclosure shall fall into the protection scope of the present disclosure.

What is claimed is:

1. A lens module, applied to an imaging device, the lens module comprising:
a first lens module, the first lens module being an autofocus module and comprising a first lens for imaging and a focus actuator for driving the first lens to perform autofocus, wherein the focus actuator comprises a first accommodating space for accommodating the first lens; and
a second lens module, the second lens module being a fixed-focus module and comprising a second lens.

2. The lens module according to claim 1, wherein the first lens module and the second lens module are arranged side by side in a direction perpendicular to a thickness direction of the first lens.

3. The lens module according to claim 2, wherein the first lens module further comprises a first anti-shake actuator for anti-shake, and the first anti-shake actuator and the focus actuator are designed into an integrated structure.

4. The lens module according to claim 1, wherein the second lens module further comprises a second anti-shake actuator for anti-shake, and the second anti-shake actuator comprising a second accommodating space for accommodating the second lens.

5. The lens module according to claim 3, wherein the second lens module further comprises a second anti-shake actuator for anti-shake, and the second anti-shake actuator comprising a second accommodating space for accommodating the second lens.

6. The lens module according to claim 1, wherein the first lens is a wide-angle lens having a first focal length f1; the second lens is a telephoto lens having a second focal length f2; the first lens module comprises a first sensor, and the first sensor has a pixel size of p1; the second lens module comprises a second sensor, and the second sensor has a pizel size of p2; the lens module has a magnification Z==(f2/f1)*(p1/2), which satisfies that Z≥2.

7. The lens module according to claim 1, wherein the thickness of the second lens module is larger than the thickness of the first lens module.
